(19) United States
(12) Patent Application Publication
(10) Pub. No.: US 2010/0191545 A1
(43) Pub. Date: Jul. 29, 2010

(54) METHODS AND PROCESSES TO TRANSFER PRECONFIGURED SYSTEMS TO REMOTE ENVIRONMENTS

(75) Inventors: Brian Heinert, Sioux Falls, SD (US); Paul Henrichs, Sioux Falls, SD (US)

Correspondence Address: HANLEY, FLIGHT & ZIMMERMAN, LLC, 150 S. WACKER DRIVE, SUITE 2100, CHICAGO, IL, 60606, US

(73) Assignee: General Electric Company, Schenectady, NY (US)

(21) Appl. No.: 12/361,859

(22) Filed: Jan. 29, 2009

(51) Int. Cl. G06Q 50/00; G06Q 90/00

(52) U.S. Cl. 705/3; 705/2

(57) ABSTRACT

Certain example embodiments provide systems, methods, processes, and/or apparatus to create and deploy preconfigured healthcare information systems to remote locations. A process to deploy a preconfigured system includes configuring a data management system installed within a virtualized environment with settings common to a plurality of network environments. The process also includes creating a portable system image on a secured media at a first location, wherein the portable system image includes an image of the first virtualized environment having the data management system installed. The process further includes transferring the portable system image to a second location. In addition, the process includes restoring the system image onto a second virtualized environment at the second location. The process also includes configuring the data management system to be communicatively coupled to at least one of an information system or a workstation at the second location.

### FIELD OF THE DISCLOSURE

The present disclosure relates generally to healthcare information systems and, more particularly, to methods and processes to transfer preconfigured healthcare information systems to remote environments.

### BACKGROUND

Healthcare environments, such as hospitals or clinics, include information systems, such as hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during and/or after surgery, medical personnel may access patient information, such as images of a patient's anatomy, that are stored in a medical information system. Radiologist and/or other clinicians may review stored images and/or other information, for example.

Using a PACS and/or other workstation, a clinician, such as a radiologist, may perform a variety of activities, such as an image reading, to facilitate a clinical workflow. A reading, such as a radiology or cardiology procedure reading, is a process of a healthcare practitioner, such as a radiologist or a cardiologist, viewing digital images of a patient. The practitioner performs a diagnosis based on a content of the diagnostic images and reports on results electronically (e.g., using dictation or otherwise) or on paper. The practitioner, such as a radiologist or cardiologist, typically uses other tools to perform diagnosis. Some examples of other tools are prior and related prior (historical) exams and their results, laboratory exams (such as blood work), allergies, pathology results, medication, alerts, document images, and other tools. For example, a radiologist or cardiologist typically looks into other systems such as laboratory information, electronic medical records, and healthcare information when reading examination results.

PACS were initially used as an information infrastructure supporting storage, distribution, and diagnostic reading of images acquired in the course of medical examinations. As PACS developed and became capable of accommodating vast volumes of information and its secure access, PACS began to expand into the information-oriented business and professional areas of diagnostic and general healthcare enterprises. For various reasons, including but not limited to a natural tendency of having one information technology (IT) department, one server room, and one data archive/backup for all departments in healthcare enterprise, as well as one desktop workstation used for all business day activities of any healthcare professional, PACS is considered as a platform for growing into a general IT solution for the majority of IT oriented services of healthcare enterprises.

### SUMMARY

Certain example embodiments provide systems, methods, processes, and/or apparatus to create and deploy preconfigured healthcare information systems to remote locations.

Certain embodiments provide a process to deploy a preconfigured system. The process includes configuring a data management system installed within a virtualized environment with settings common to a plurality of network environments. The process also includes creating a portable system image on a secured media at a first location, wherein the portable system image includes an image of the first virtualized environment having the data management system installed. The process further includes transferring the portable system image to a second location. In addition, the process includes restoring the system image onto a second virtualized environment at the second location. The process also includes configuring the data management system to be communicatively coupled to at least one of an information system or a workstation at the second location.

Certain embodiments provide an apparatus to create a portable system image. The apparatus includes a configurator to configure a base system with settings common to a plurality of network environments. The base system includes a data management system installed within a virtualized environment. The apparatus also includes an image creator to create an image of the virtualized environment containing the base system. The apparatus further includes a media creator to create the portable system image on a secured media from the created image of the virtualized environment.

Certain embodiments provide a method of creating a portable system image. The method includes configuring a data management system installed on a virtual machine with settings common to a plurality of network environments. The method also includes creating an image of the virtual machine containing the configured application. The method further includes generating a portable system image on secured media with the image of the virtual machine.

Certain embodiments provide a computer-readable medium having a set of instructions for execution on a computing device. The set of instructions execute a method for creating a portable system image. The method includes configuring at least one application installed on a virtual machine with settings common to a plurality of network environments. The method also includes creating an image of the virtual machine containing the configured application. The method further includes generating a portable system image on secured media from the image of the virtual machine. The method additionally includes facilitating restoration and configuration of the image of the virtual machine from the portable system image.

### BRIEF DESCRIPTION OF THE DRAWINGS

FIG. 1 is a block diagram of an example healthcare information system.

FIG. 2 illustrates an example portable image generation and deployment system in accordance with certain embodiments.

FIG. 3 depicts a flow diagram for a method for transferring a portable healthcare information system image in accordance with certain embodiments.

FIG. 4 depicts a flow diagram for a method for creating a portable healthcare information system in accordance with certain embodiments.

FIG. 5 depicts a flow diagram for a method for restoring a portable system in accordance with certain embodiments.

FIG. 6 is a diagram showing example components and process follow for both creation and deployment of a portable healthcare information system at a client location.

FIG. 7 is a block diagram of an example processor system that may be used to execute the machine readable instructions of FIGS. 4, 5 and/or 6 to implement the example systems of FIGS. 1 and/or 2.

The foregoing summary, as well as the following detailed description of certain implementations of the methods, apparatus, systems, and/or articles of manufacture described herein, will be better understood when read in conjunction with the appended drawings. It should be understood, however, that the methods, apparatus, systems, and/or articles of manufacture described herein are not limited to the arrangements and instrumentality shown in the attached drawings.

### DETAILED DESCRIPTION

Although the following discloses example methods, apparatus, systems, and articles of manufacture including, among other components, firmware and/or software executed on hardware, it should be noted that such methods, apparatus, systems, and/or articles of manufacture are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

Certain examples provide systems and methods to transfer portable systems onto protected and secured media for distribution to remote environments. Certain examples facilitate healthcare information system portability and facilitate faster deployment, hardware independence, and product flexibility. In some examples, information system infrastructure and related assets can be sold and distributed, including preconfigured systems that can be distributed as purchased. In addition to large data centers with a single location, preconfigured systems can be deployed to a distributed customer base located globally with many locations, including isolated environments where large scale shared network deployment concepts have previously been prevalent.

In certain examples, rather than turnkey systems tied to a physical hardware platform, systems can be hardware independent and marketed in two varieties: 1) a turnkey for customers without an infrastructure, and/or 2) a preconfigured system image sold on a protected and secured media for customers that have their infrastructure already in place. This can allow the customer scalability in purchasing and deploying additional systems in his or her environment without incurring additional hardware costs, for example.

Certain examples provide system portability and distribution of systems on an as-needed basis to customers without incurring additional hardware costs in deployment. Certain example systems can be offered as a turnkey solution and/or as a preconfigured system image. Certain examples provide hardware independence and product flexibility in faster, more reliable, and increasingly error proof system configuration.

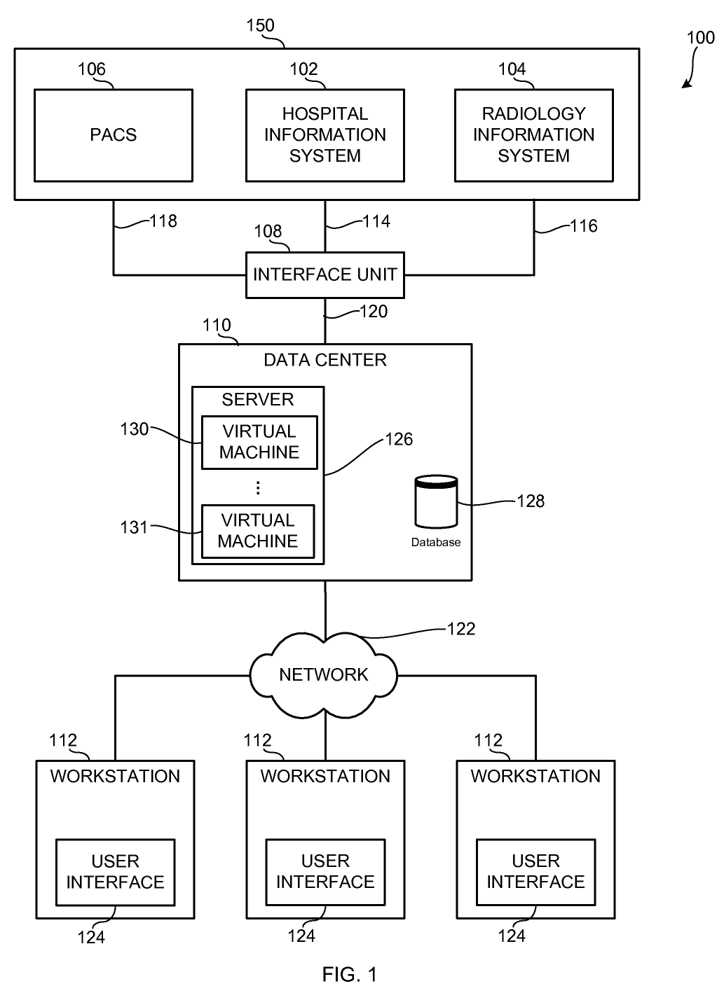

FIG. 1 is a block diagram of an example healthcare information system 100. The medical information system 100 and its components can be represented in hardware, software, and/or firmware in various combinations. Some or all components of the healthcare information system 100 can be represented as a preconfigured system image for deployment to a customer, for example. Alternatively and/or in addition, components of the healthcare information system 100 can be used to implement example methods and apparatus described herein to create and/or transfer preconfigured systems to remote environments, for example. Components of the healthcare information system 100 can be implemented individually and/or in one or more combinations in software, hardware, and/or firmware, for example.

The example healthcare information system 100 includes a hospital information system 102, a radiology information system 104, a picture archiving and communication system (PACS) 106, an interface unit 108, a data center 110, and a plurality of workstations 112. In the illustrated example, the hospital information system 102, the radiology information system 104, and the PACS 106 are housed in a healthcare facility and locally archived. However, in other implementations, the hospital information system 102, the radiology information system 104, and/or the PACS 106 may be housed one or more other suitable locations. Furthermore, one or more components of the medical information system 100 may be combined and/or implemented together. For example, the radiology information system 104 and/or the PACS 106 may be integrated with the hospital information system 102; the PACS 106 may be integrated with the radiology information system 104; and/or the three example information systems 102, 104, and/or 106 may be integrated together. In other example implementations, the healthcare information system 100 includes a subset of the illustrated information systems 102, 104, and/or 106. For example, the healthcare information system 100 may include only one or two of the hospital information system 102, the radiology information system 104, and/or the PACS 106. Preferably, information (e.g., test results, observations, diagnosis, etc.) is entered into the hospital information system 102, the radiology information system 104, and/or the PACS 106 by healthcare practitioners (e.g., radiologists, physicians, and/or technicians) before and/or after patient examination.

The hospital information system 102 stores medical information such as clinical reports, patient information, and/or administrative information received from, for example, personnel at a hospital, clinic, and/or a physician's office. The radiology information system 104 stores information such as, for example, radiology reports, messages, warnings, alerts, patient scheduling information, patient demographic data, patient tracking information, and/or physician and patient status monitors. Additionally, the radiology information system 104 enables exam order entry (e.g., ordering an x-ray of a patient) and image and film tracking (e.g., tracking identities of one or more people that have checked out a film). In some examples, information in the radiology information system 104 is formatted according to the HL-7 (Health Level Seven) clinical communication protocol.

The PACS 106 stores medical images (e.g., x-rays, scans, three-dimensional renderings, etc.) as, for example, digital images in a database or registry. In some examples, the medical images are stored in the PACS 106 using the Digital Imaging and Communications in Medicine (DICOM) format. Images are stored in the PACS 106 by healthcare practitioners (e.g., imaging technicians, physicians, radiologists) after a medical imaging of a patient and/or are automatically transmitted from medical imaging devices to the PACS 106 for storage. In some examples, the PACS 106 may also include a display device and/or viewing workstation to enable a healthcare practitioner to communicate (e.g., review images) with the PACS 106.

The interface unit 108 includes a hospital information system interface connection 114, a radiology information system interface connection 116, a PACS interface connection 118, and a data center interface connection 120. The interface unit 108 facilitates communication among the hospital information system 102, the radiology information system 104, the PACS 106, and/or the data center 110. The interface connections 114, 116, 118, and 120 may be implemented by, for example, a Wide Area Network (WAN) such as a private network or the Internet. Accordingly, the interface unit 108 includes one or more communication components such as, for example, an Ethernet device, an asynchronous transfer mode (ATM) device, an 802.11 device, a DSL modem, a cable modem, a cellular modem, etc. In turn, the data center 110 communicates with the plurality of workstations 112, via a network 122, implemented at a plurality of locations (e.g., a hospital, clinic, doctor's office, other medical office, or terminal, etc.). The network 122 is implemented by, for example, the Internet, an intranet, a private network, a wired or wireless Local Area Network, and/or a wired or wireless Wide Area Network. In some examples, the interface unit 108 also includes a broker (e.g., a Mitra Imaging's PACS Broker) to allow medical information and medical images to be transmitted together and stored together.

In operation, the interface unit 108 receives images, medical reports, administrative information, and/or other clinical information from the information systems 102, 104, 106 via the interface connections 114, 116, 118. If necessary (e.g., when different formats of the received information are incompatible), the interface unit 108 translates or reformats (e.g., into Structured Query Language (SQL or standard text) the medical information, such as medical reports, to be properly stored at the data center 110. Preferably, the reformatted medical information may be transmitted using a transmission protocol to enable different medical information to share common identification elements, such as a patient name or social security number. Next, the interface unit 108 transmits the medical information to the data center 110 via the data center interface connection 120. Finally, medical information is stored in the data center 110 in, for example, the DICOM format, which enables medical images and corresponding medical information to be transmitted and stored together.

The medical information is later viewable and easily retrievable at one or more of the workstations 112 (e.g., by their common identification element, such as a patient name or record number). The workstations 112 may be any equipment (e.g., a personal computer) capable of executing software that permits electronic data (e.g., medical reports) and/or electronic medical images (e.g., x-rays, ultrasounds, MRI scans, etc.) to be acquired, stored, or transmitted for viewing and operation. The workstations 112 receive commands and/or other input from a user via, for example, a keyboard, mouse, track ball, microphone, etc. As shown in FIG. 1, the workstations 112 are connected to the network 122 and, thus, can communicate with each other, the data center 110, and/or any other device coupled to the network 122. The workstations 112 are capable of implementing a user interface 124 to enable a healthcare practitioner to interact with the medical information system 100. For example, in response to a request from a physician, the user interface 124 presents a patient medical history. Additionally, the user interface 124 includes one or more options related to the example methods and apparatus described herein to organize such a medical history using classification and severity parameters.

The example data center 110 of FIG. 1 is an archive to store information such as, for example, images, data, medical reports, and/or, more generally, patient medical records. In addition, the data center 110 may also serve as a central conduit to information located at other sources such as, for example, local archives, hospital information systems/radiology information systems (e.g., the hospital information system 102 and/or the radiology information system 104), or medical imaging systems (e.g., the PACS 106). That is, the data center 110 may store links or indicators (e.g., identification numbers, patient names, or record numbers) to information. In the illustrated example, the data center 110 is managed by an application server provider (ASP) and is located in a centralized location that may be accessed by a plurality of systems and facilities (e.g., hospitals, clinics, doctor's offices, other medical offices, and/or terminals). In some examples, the data center 110 may be spatially distant from the hospital information system 102, the radiology information system 104, and/or the PACS 106 (e.g., at General Electric® headquarters).

The example data center 110 of FIG. 1 includes a server 126 and a data store 128. The server 126 receives, processes, and conveys information to and from the components of the medical information system 100. The data store 128 stores the medical information described herein and provides access thereto. The server 126 can include and/or be used to instantiate one or more virtual machines 130, 131 upon which processes and/or components, such as components of the healthcare information system 100 can be run. As will be discussed further below, a computer/processor, such as the server 126, can be used to configure a healthcare information system for storage on a secure media via a virtual machine 130, 131. The stored system image can be placed on a portable media for deployment at a remote location, for example.

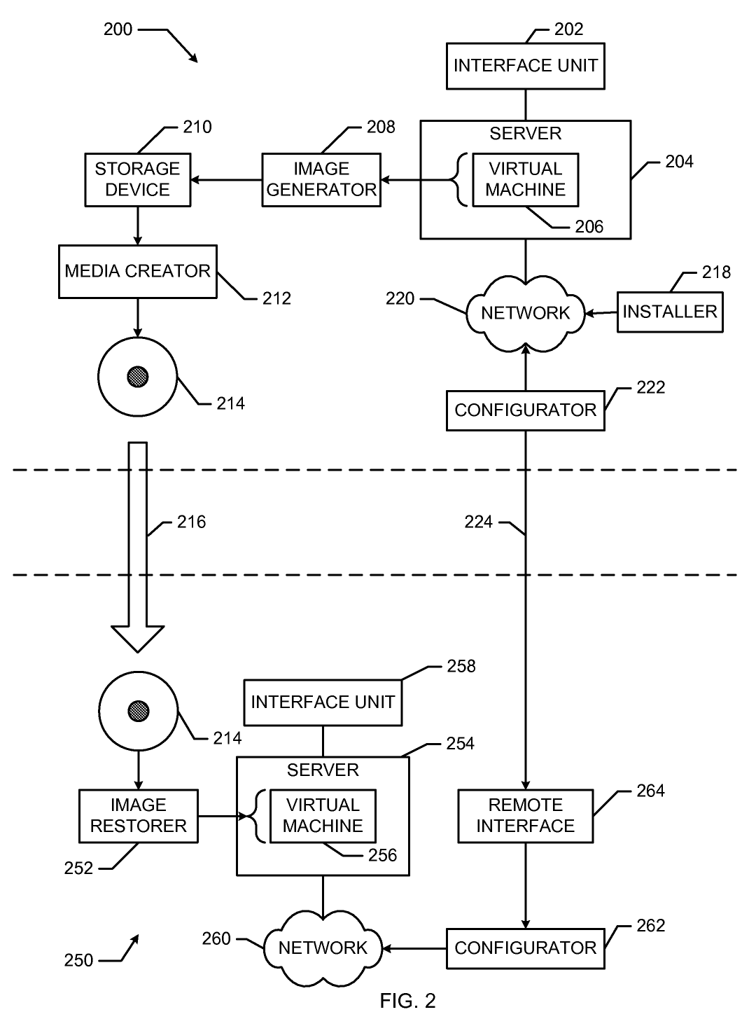

FIG. 2 illustrates an example portable image generation and deployment system 200 in accordance with certain embodiments. Components of the system 200 can be implemented separately and/or in one or more combinations of hardware, software, and/or firmware, for example. The system 200 includes an interface unit 202 (e.g., a keyboard, mouse, Web portal, computer/processor, and/or other interface software, hardware, and/or firmware) that allows a user to interact with a server 204 including one or more virtual machines 206. Upon instruction from the interface unit 202 and/or software instructions on the server 204, the server 204 generates the virtual machine 206. The virtual machine 206 includes and/or interacts with an image generator 208 to generate an image or instruction/software code snapshot of a healthcare information system. The image generator 208 forms a system image that can be modified and/or configured based on certain system and/or user rules, parameters, and/or edits, for example.

The resulting system image is provided to a storage device 210 to store the image information. The storage device 210 can include and/or be in communication with a media creator 212. The media creator 212 can be used to generate a portable media 214 (e.g., a CD-ROM, a DVD, a flash memory, a USB drive, a portable hard disk drive, etc.) including the system image. The portable media 214 can be protected and secured to prevent tampering and/or theft of the system image content, for example. The portable media 214 can be transmitted to a remote location via a distribution channel 216, such as via hand delivery, shipping, electronic communication, and the like.

The portable media 214 is received at a remote location 250 and provided to an image restorer 252. The image restorer 252 processes the system image stored on the media 214 and provides the system image to a server 254. The server 254 creates a virtual machine 256 on which to restore and run the healthcare information system. Deployment of the system image on the virtual machine 256 can be controlled and/or modified by input from an interface unit 258, similar to the interface unit 202 described above.

Additionally, information related to the deployment and configuration of the system image can be provided remotely via network 260 to the server 254 and its virtual machine 256. For example, a configure 262 can be in communication with a remote interface 264 that receives and/or transmits instructions and other information to the server 254. The remote interface 264 can be in communication with a configurator 222 via a communication channel 224. For example, the configurator 222 can be located at a system image creation site 200, and the configurator 262 can be located at a remote system deployment site 250. The configurator 222 can transmit and receive information to aid in the configuration of the system image at the remote server 254, for example. The configurator 222 can receive input from the server 204 and/or an installer 218 communication via a common network 220, for example. In some examples, the configurator 222 can also provide feedback to the server 204 and its virtual machine 206 (and/or the installer 218) via the remote communication channel 224.

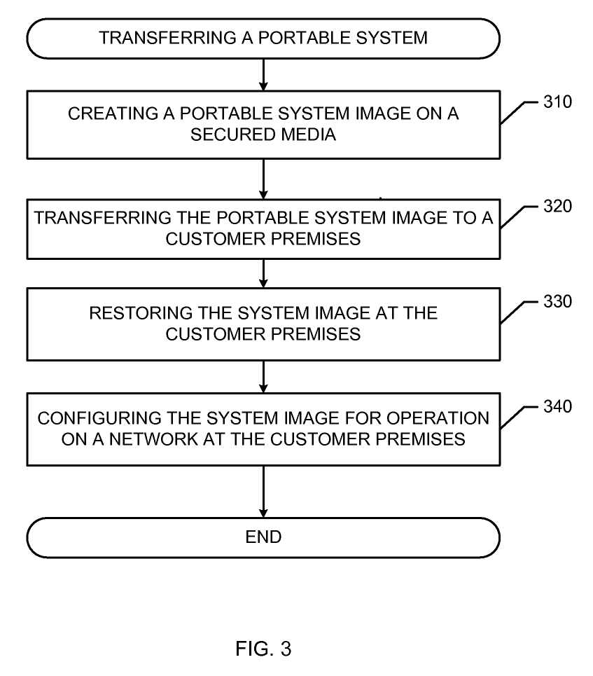

FIG. 3 depicts a flow diagram for a method 300 for transferring a portable healthcare information system image in accordance with certain embodiments. At 310, a portable system image is created on a secured media. For example, computer and/or other machine readable/executable code representing a healthcare information system, such as a Picture Archiving and Communication System (PACS), a Radiology Information System (RIS), a Clinical Information System (CIS), a Cardiovascular Information System (CVIS), an Electronic Medical Records system (EMR), a Laboratory Information System (LIS), and/or the like can be represented as a coded system image.

At 320, the portable system image stored on the secured media is transferred to a second location (e.g., a customer premises). For example, the system image can be encoded and/or otherwise securely stored on media such as a disk (e.g., a CD, a DVD, a hard disk drive), a read-only memory (ROM), a programmable read-only memory (PROM), an electrically erasable programmable read-only memory (EEPROM), etc.

At 330, the system image is restored at the second location (e.g., the customer premises). For example, a customer site receiving the media can insert and/or otherwise place the media in communication with a computing/processing device (e.g., a computer server) at the customer site and execute code on the media (automatically upon recognition of the media by the computing/processing device and/or upon local or remote user initiation, for example) to extract and restore the system image on the media to a healthcare information system executing on the device at the second location.

At 340, the system image is configured for operation on a network at the second location (e.g., the customer premises). For example, remote interaction can be facilitated to allow a remote system and/or user to configure parameters, settings, and/or other information regarding the system deployment from a stored image to a system running on a virtual machine. Alternatively and/or in addition, a local user at the second location can configure options for system setup and operation, for example.

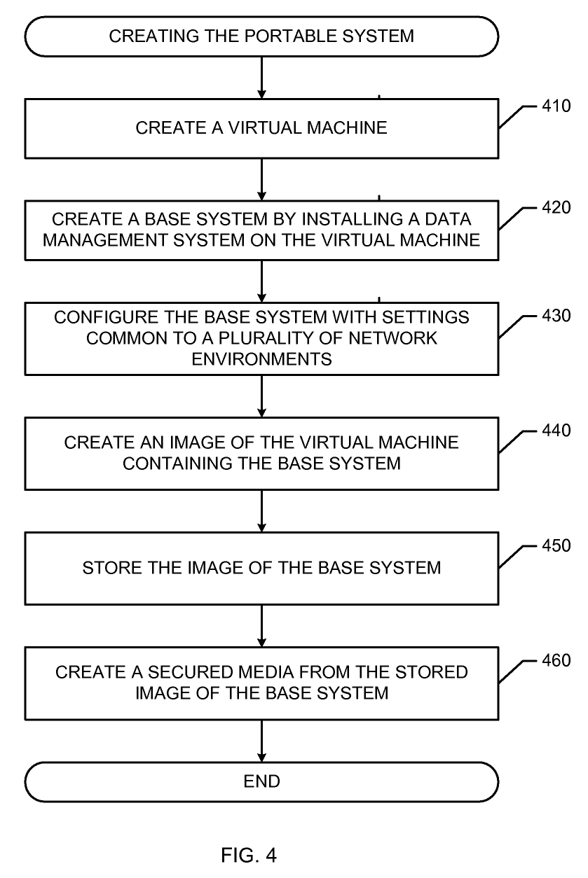

FIG. 4 depicts a flow diagram for a method 400 for creating a portable healthcare information system in accordance with certain embodiments. At 410, a virtual machine is created. For example, a software program and/or environment running on underlying hardware, such as a server, can be generated to support execution of software on the virtual machine based on the configured parameters of the virtual machine. The virtual machine can be used to emulate software, hardware, and/or firmware functionality of a variety of different systems based on the configuration of the virtual machine. In some examples, rather than creating a virtual machine, processes can be executed directly on the underlying physical machine. In some examples, an underlying physical machine can spawn and support multiple virtual machines running the same and/or different software.

At 420, a base system is created by installing a data management system on the virtual machine. For example, software representing a data management system and its functionality is installed on the virtual machine such that the virtual machine is providing the functionality of the data management system.

At 430, the base system is configured with settings common to a plurality of network environments. For example, “standard” or default setting can be applied to the configuration of the base systems based on one or more criteria and/or user preferences. As another example, setting configuration can be applied based on a particular target network environment and/or set of network environments.

At 440, an image is created of the virtual machine including the base system. For example, the contents of the configured base system running on the virtual machine are copied. The image includes configuration, setting, and/or state information for the base system (e.g., the data management system), for example.

At 450, the image of the base system is stored. For example, the created image can be saved to a disk and/or other programmable media.

At 460, a secured media is created from the stored image of the base system. For example, image data stored on the media can encoded, encrypted, write-protected, access-protected, and/or otherwise secured against tampering and/or unauthorized use.

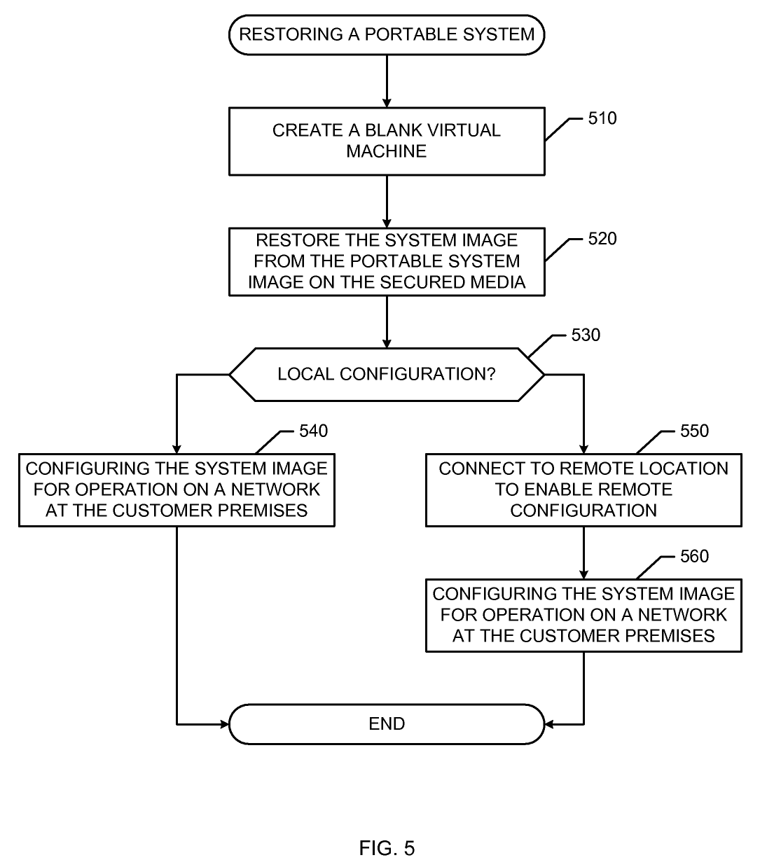

FIG. 5 depicts a flow diagram for a method 500 for restoring a portable system in accordance with certain embodiments. At 510, a blank virtual machine is created. For example, a program executing on a computing/processing machine can be used to instantiate a virtual representation of a computing/processing system and/or a process/application that emulates the capabilities and operation of the system and/or process it represents.

At 520, a system image is restored from a portable system image stored on a secured media. For example, the secured media is accessed to copy and/or otherwise extract the system image onto the virtual machine.

At 530, local configuration information is identified. For example, parameters and/or other settings associated with a particular location are identified.

At 540, if local configuration is being attempted, the system image is configured for operation on a network at the customer premises. For example, a local user and/or program can configure the system restoration according to particular settings, parameters, and/or other preferences at the customer site.

At 550, if local configuration is not being attempted, a connection to a remote location is established to enable remote configuration of the portable system. For example, the customer site server can connect (e.g., via an Ethernet, private network, and/or other wired and/or wireless data connection) to a remote server and/or other installation/configuration device to receive input from the remote device.

At 560, the system image is configured for operation on a network at the customer premises. For example, after connecting to a remote system, a remote user and/or program can configure the restored system according to particular settings, parameters, and/or other preferences for operation at the customer site.

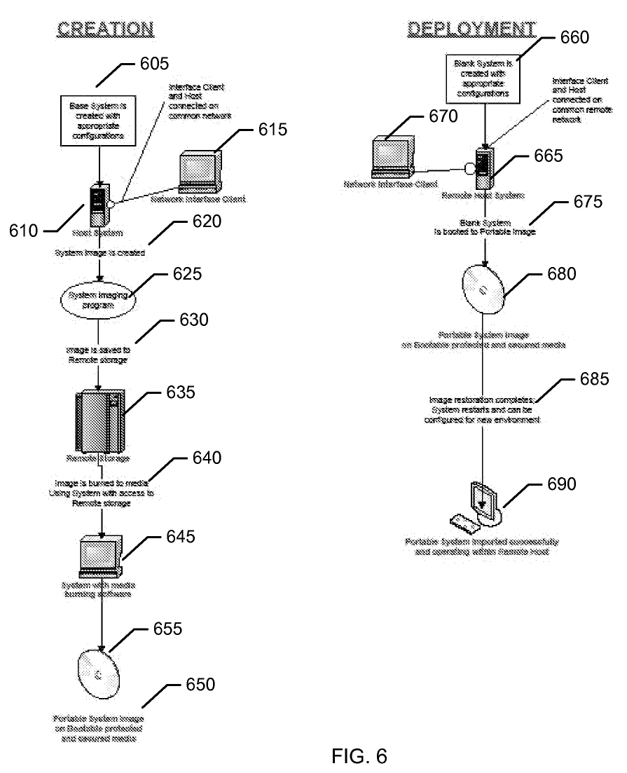

FIG. 6 is a diagram showing example components and process follow for both creation and deployment of a portable healthcare information system at a client location. As shown in FIG. 6, at 605, a base system is created with appropriate configuration information based on certain rules, guidelines, client needs/requests, etc. The base system is created at a host system 610, for example. A network interface client 615 can be used to trigger, control, and/or modify the base system generation, for example. The interface client 615 and the host system 610 can be connected on a common network, for example.

A system image is then created 620 for the base system using a system imaging program 625, such as a system imaging program running on the host system 610, for example. The system image is saved 630 to a remote storage 635. For example, a remote archive, application service provider, data store, application server, etc., can be used to store the system image. At 640, the system image is burned and/or otherwise stored 640 to a computer and/or other machine readable/accessible media using a system 645 having access to the remote storage 635 and having media burning and/or other transferring software and/or hardware running on the system 645. At 650, a portable system image is stored on a bootable protected and secured media 655.

At 660, a blank system is created with appropriate configurations at a remote host system 665. The remote host system 665 can interact with and/or take direction from a network interface client 670. The interface client 670 and the remote host system 665 can be connected on a common remote network, for example. At 675, the blank system is booted using a portable system image 680, which can be the same as or similar to the portable system image 655 on a bootable protected and secured media, for example.

At 685, system image restoration completes. As part of the image restoration, the system can reboot or restart, for example. The restored system can be configured for its new environment, for example. At 690, the portable system has been imported, configured, and operates within the remote host 665.

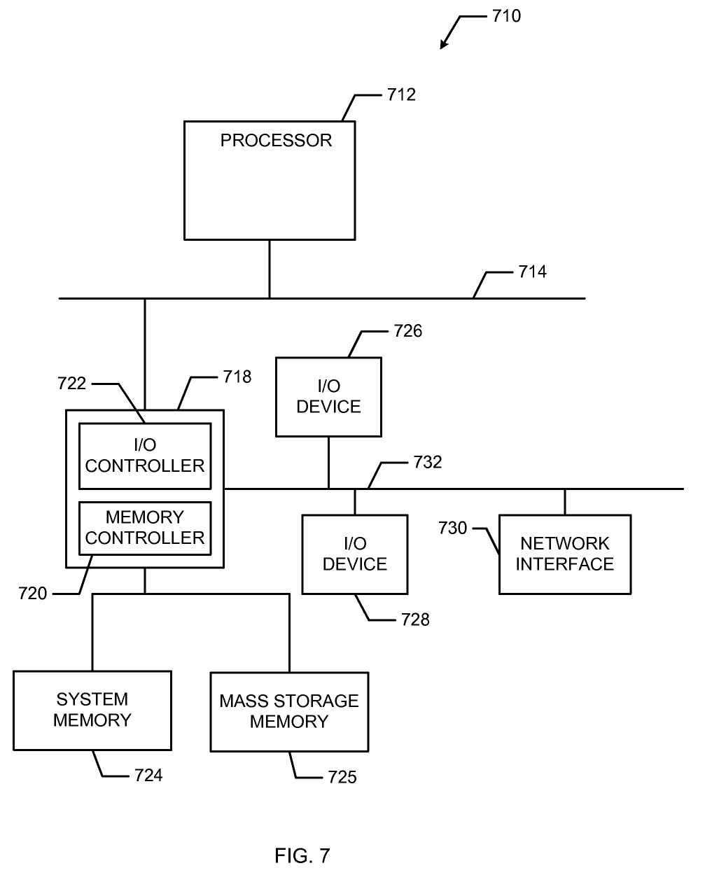

FIG. 7 is a block diagram of an example processor system 710 that may be used to implement at least certain systems, apparatus, and/or methods described herein. As shown in FIG. 7, the processor system 710 includes a processor 712 that is coupled to an interconnection bus 714. The processor 712 may be any suitable processor, processing unit or microprocessor. Although not shown in FIG. 7, the system 710 may be a multi-processor system and, thus, may include one or more additional processors that are identical or similar to the processor 712 and that are communicatively coupled to the interconnection bus 714.

The processor 712 of FIG. 7 is coupled to a chipset 718, which includes a memory controller 720 and an input/output (I/O) controller 722. As is well known, a chipset typically provides I/O and memory management functions as well as a plurality of general purpose and/or special purpose registers, timers, etc. that are accessible or used by one or more processors coupled to the chipset 718. The memory controller 720 performs functions that enable the processor 712 (or processors if there are multiple processors) to access a system memory 724 and a mass storage memory 725.

The system memory 724 may include any desired type of volatile and/or non-volatile memory such as, for example, static random access memory (SRAM), dynamic random access memory (DRAM), flash memory, read-only memory (ROM), etc. The mass storage memory 725 may include any desired type of mass storage device including hard disk drives, optical drives, tape storage devices, etc.

The I/O controller 722 performs functions that enable the processor 712 to communicate with peripheral input/output (I/O) devices 726 and 728 and a network interface 730 via an I/O bus 732. The I/O devices 726 and 728 may be any desired type of I/O device such as, for example, a keyboard, a video display or monitor, a mouse, etc. The network interface 730 may be, for example, an Ethernet device, an asynchronous transfer mode (ATM) device, an 802.11 device, a DSL modem, a cable modem, a cellular modem, etc. that enables the processor system 710 to communicate with another processor system.

While the memory controller 720 and the I/O controller 722 are depicted in FIG. 7 as separate blocks within the chipset 718, the functions performed by these blocks may be integrated within a single semiconductor circuit or may be implemented using two or more separate integrated circuits.

Thus, certain embodiments provide systems, methods, and computer program products that create and deploy turnkey healthcare information systems for customer use. Certain embodiments provide preconfigured system images for easier deployment at a customer site. Certain embodiments provide healthcare information systems instantiated on virtual machines for execution at customer sites. Certain embodiments provide a technical effect of healthcare information system creation and deployment from a first location to a second location with little or no configuration necessary at the second location.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A process to deploy a preconfigured system comprising:
configuring a data management system installed within a virtualized environment with settings common to a plurality of network environments;
creating a portable system image on a secured media at a first location, wherein the portable system image comprises an image of the first virtualized environment having the data management system installed;
transferring the portable system image to a second location;
restoring the system image onto a second virtualized environment at the second location; and
configuring the data management system to be communicatively coupled to at least one of an information system or a workstation at the second location.

2. A process as defined in claim 1, wherein the first location is one of a software manufacturing location or a software distribution center.

3. A process as defined in claim 1, wherein the virtualized environment is a virtual machine having an operating system.

4. A process as defined in claim 1, further comprising configuring the data management system installed in the first virtualized environment to be communicatively coupled to at least one of an information system or a workstation.

5. A process as defined in claim 4, wherein the information system comprises an information system for use in healthcare environment, an industrial environment, or a financial environment.

6. A process as defined in claim 5, wherein the information system comprises at least one of a healthcare information system (HIS), a radiology information system (RIS), a clinical information system (CIS), a cardiovascular information system (CVIS), a picture archiving and communication system (PACS), a library information systems (LIS), or an electronic medical record system (EMR).

7. A process as defined in claim 1, wherein the information system comprises at least one of a healthcare information system (HIS), a radiology information system (RIS), a clinical information system (CIS), a cardiovascular information system (CVIS), a picture archiving and communication system (PACS), a library information systems (LIS), or an electronic medical record system (EMR).

8. A process as defined in claim 1, wherein the portable system image on secured media comprises an installation program on a protected and bootable media.

9. An apparatus to create a portable system image comprising:
a configurator to configure a base system with settings common to a plurality of network environments, the base system comprising a data management system installed within a virtualized environment;
an image creator to create an image of the virtualized environment containing the base system; and
a media creator to create the portable system image on a secured media from the created image of the virtualized environment.

10. An apparatus as defined in claim 9, wherein the configurator is further configured to configure the data management system to communicatively couple the data management system to at least one of an information system or a workstation.

11. An apparatus as defined in claim 10, wherein the configurator is at a first location and at least one of the information system or workstation is at a second location.

12. An apparatus as defined in claim 11, wherein the created portable system image is to be restored at the second location.

13. A method of creating a portable system image comprising:
configuring a data management system installed on a virtual machine with settings common to a plurality of network environments;
creating an image of the virtual machine containing the configured application; and
generating a portable system image on secured media with the image of the virtual machine.

14. A method as defined in claim 13, wherein configuring the data management system comprises settings to communicatively couple the data management system to at least one information system or workstation;

15. A method as defined in claim 14, wherein the information system comprises an information system for use in healthcare environment, an industrial environment, or a financial environment.

16. A method as defined in claim 14, wherein the information system comprises at least one of a healthcare information system (HIS), a radiology information system (RIS), a clinical information system (CIS), a cardiovascular information system (CVIS), a picture archiving and communication system (PACS), a library information systems (LIS), or an electronic medical record system (EMR).

17. A method as defined in claim 13, wherein the settings common to a plurality of network environments are network settings or application settings.

18. A method as defined in claim 13, wherein creating an image of the virtual machine further comprises cloning the virtual machine and storing the cloned virtual image in at least one file.

19. A computer-readable medium having a set of instructions for execution on a computing device, the set of instructions executing a method for creating a portable system image, the method comprising:
configuring at least one application installed on a virtual machine with settings common to a plurality of network environments;
creating an image of the virtual machine containing the configured application;
generating a portable system image on secured media from the image of the virtual machine; and
facilitating restoration and configuration of the image of the virtual machine from the portable system image.

20. A computer-readable medium as defined in claim 19, wherein the image of the virtual machine represents at least one of a healthcare information system (HIS), a radiology information system (RIS), a clinical information system (CIS), a cardiovascular information system (CVIS), a picture archiving and communication system (PACS), a library information systems (LIS), or an electronic medical record system (EMR).
